(19) United States
(12) Patent Application Publication
(10) Pub. No.: US 2015/0299421 A1
(43) Pub. Date: Oct. 22, 2015

(54) Production of Boron Carbide Powder

(71) Applicant: THE UNIVERSITY OF BIRMINGHAM, Birmingham (GB)

(72) Inventors: Isaac Tsz Hong Chang, Birmingham (GB); Constantin Lucian Falticeanu, Redditch (GB)

(21) Appl. No.: 14/443,249

(22) PCT Filed: Nov. 11, 2013
(86) PCT No.: PCT/GB2013/052952

§ 371 Date: May 15, 2015

(30) Foreign Application Priority Data
Nov. 19, 2012 (GB) 1220765.0

(51) Int. Cl. C08K 3/34; C08K 3/38; C01B 31/36

(52) U.S. Cl. CPC C08K 3/34; C01B 31/36; C08K 3/38

(57) ABSTRACT

The invention relates to a method of producing boron carbide powder. The method comprises (i) forming a liquid precursor from a carbon source; (ii) forming solid precursor particles from the liquid precursor; (iii) subjecting the solid precursor particles to pyrolysis; and (iv) subjecting the pyrolysed solid precursor particles to a carbothermal reduction process. A boron source is introduced during one of steps (i) to (iv) such that the carbothermal reduction process results in the production of boron carbide powder.

The present invention relates to the production of boron carbide powder, in particular to a method of producing boron carbon powder from solid precursor particles.

Boron carbide powder is used for the manufacture of sintered components such as bullet proof panels for ballistic protection because of its high hardness, high strength and low density.

The use of powders having small average particle sizes (i.e. no greater than 20 microns) for sintered components is preferable as small particle size gives improved consolidation of powder components at a given sintering temperature, resulting in a suitable sintered density and desirable mechanical properties.

The commercial production of boron carbide powders is normally carried out by a carbothermic reduction method using an electric arc furnace that operates at high temperatures to produce boron carbide, followed by intensive grinding of the boron carbide ingot into fine powders which are suitable for sintering. Sub-micron particles can be obtained through grinding but this is a very time- and resource-intensive process.

Boron carbide powder having an average particle size of 10 μm is commercially available. This is a compromise between the energy-intensive sub-micron powder, and powder which has a small enough particle size to yield components of reasonable density and mechanical properties when consolidated under temperature and pressure (known as hot pressing). However, hot pressing using this type of powder is an expensive process and places limits on the size and/or shape of components that can be produced.

A method known in the art for producing a boron carbide powder is described in U.S. Pat. No. 3,379,647. This method involves a carbothermic reduction of boron oxide. A solution comprising a carbon source and a boron oxide source is prepared and then heated to produce a dry black solid. The solid is then fired at a temperature in the range of 1700° C.-2100° C., thereby reducing the boron oxide which is present initially with the boron carbide being produced as the boron oxide reduction progresses. However, the boron carbide powder produced has a wide particle size distribution ranging from 0.5 to 150 microns.

U.S. Pat. No. 7,635,458 describes a method for making ultrafine boron carbide particles by introducing a liquid boron-containing precursor and a carbon-containing precursor into a plasma, heating the precursors by the plasma to form ultrafine boron carbide particles, quenching and collecting the ultrafine boron carbide particles. The use of plasma to heat the precursor materials to a temperature in the range of 1700° C. to 8000° C. makes this a very energy intensive process.

Research in this field has focused on the development of a solid polymer precursor. In particular, the synthesis of polyvinylborate (PVBO) is performed by reacting polyvinyl alcohol with boron oxide solution. The solid precursor is a gel and requires manual grinding to produce fine powders prior to subsequent pyrolysis in air and then heat treatment at temperatures up to 1500° C. to allow the conversion to micron-sized boron carbide powders by carbothermal reduction.

The known production routes for the manufacture of boron carbide powders typically result in a high level of residual carbon in the boron carbide powder, which leads to less than optimum properties in components manufactured from the powder.

There is a need for a process to manufacture boron carbide powder having a reduced particle size range and with a low residual carbon content, which eliminates the need for the intensive grinding step and that is scalable for production volumes and costs.

According to a first aspect of the invention, there is provided a method of producing boron carbide powder, the method comprising the steps of:

(i) forming a liquid precursor from a carbon source;

(ii) forming solid precursor particles from the liquid precursor;

(iii) subjecting the solid precursor particles to pyrolysis; and

(iv) subjecting the pyrolysed solid precursor particles to a carbothermal reduction process,

wherein a boron source is introduced during one of steps (i) to (iv) such that the carbothermal reduction process results in the production of boron carbide powder.

The boron source may be introduced during the formation of the liquid precursor (step (i)), the formation of the solid precursor particles (step (ii)), during pyrolysis (step (iii)), or during the carbothermal reduction process (step (iv)). In some embodiments, the boron source is introduced in the form of a gas. In these embodiments, the method comprises the steps of:

(i) forming a liquid precursor from a carbon source;

(ii) forming solid precursor particles from the liquid precursor;

(iii) subjecting the solid precursor particles to pyrolysis; and

(iv) subjecting the pyrolysed solid precursor particles to a carbothermal reduction process,

wherein at least one of steps (ii), (iii) and (iv) is carried out in the presence of a gaseous boron source.

In some particular embodiments, the pyrolysed solid precursor particles are subjected to carbothermal reduction in the presence of a gaseous boron source. Since a gaseous boron source is in a highly reactive state, this may allow the temperature of the carbothermal reduction process to be reduced.

The gaseous boron source may be borane.

In some embodiments, the boron source is introduced into the liquid precursor. Thus, in some embodiments, the method comprises:

(i) forming a liquid precursor from a boron source and a carbon source;

(ii) forming solid precursor particles from the liquid precursor;

(iii) subjecting the solid precursor particles to pyrolysis; and

(iv) subjecting the pyrolysed solid precursor particles to a carbothermal reduction process to produce boron carbide powder.

The use of a liquid precursor comprising both a carbon source and a boron source allows the carbon and boron to be closely mixed. It may also be cheaper and safer than using a gaseous boron source.

In some embodiments, the liquid precursor is a suspension, i.e. in which a carbon source and, optionally, a boron source is suspended in a liquid or solution. It is preferred that very fine solid constituents are used to achieve uniform distribution of the carbon and/or boron sources in the solid precursor particles. For example, the liquid precursor may be a suspension of ultrafine carbon black powder in an aqueous solution of boric acid.

In some embodiments, the liquid precursor is a solution. For example, the solution may be one in which the carbon source and/or the boron source (if present) is dissolved in a solvent. The solvent may be any suitable solvent in which the carbon source, and the boron source when present, is soluble, and which has suitable properties for the formation of the solid precursor particles from the liquid precursor using the methods described herein. Suitable solvents would be apparent to the skilled person (e.g. ethanol and polyethylene glycol). In some embodiments, the solvent is water, i.e. the liquid precursor is an aqueous solution. Wherein the liquid precursor contains both a carbon source and a boron source, a solution is particularly advantageous since the carbon and boron sources are mixed at the molecular level. Solid precursor particles formed from a homogenous solution are chemically uniform.

In embodiments wherein the liquid precursor is formed from a carbon source and a boron source, the boron source may any suitable boron-based compound. In some embodiments, the boron source is one which is soluble in water at a temperature of up to about 100° C. The boron source may be boron oxide (B₂O₃). In embodiments wherein the solvent for the liquid precursor solution is water, the addition of a boron source such as boron oxide to the water produces a solution of boric acid.

It will be appreciated that the liquid precursor may be formed by any suitable method. For example, the liquid precursor may be formed by dissolving a solid carbon and/or a boron source (e.g. in the form of powders, granules or pellets) in a solvent. Alternatively, the carbon and/or boron source may be added in form of a liquid or a solution. For example, an aqueous liquid precursor solution may be formed by first dissolving a solid boron source in water and then adding a carbon source in the form of a solution.

The carbon source may be any organic material comprising carbon and hydrogen. In some embodiments, the carbon source is one which is soluble in water at a temperature up to about 100° C. For example, the carbon source may be selected from sugars (e.g. glucose, fructose, sucrose), polysaccharides (e.g. starch, cellulose), hydrocarbons (including alkanes, alkenes and aromatic hydrocarbons), acids (e.g. citric acid), esters, alcohols and the like. In some embodiments the carbon source is starch. In some further embodiments the carbon source is modified starch. By “modified” it will be understood that the natural structure of the starch molecule has been altered physically, chemically or enzymatically, for example, by adding, removing or modifying chemical groups present in the molecule. In other words, the compound is a derivative of starch. The modification changes the properties of the starch, for example, by increasing its solubility in water and/or by increasing its thermal stability.

In some embodiments wherein the liquid precursor comprises both carbon and boron, the relative amounts of the carbon and boron sources used to form the liquid precursor are such that the molar ratio of boron atoms to carbon atoms is from 1:1.5 to 1:2, from 1:1.7 to 1:1.9 or from 1:1.75 to 1:1.80. In some embodiments wherein boron oxide is used as the source of boron, the stoichiometric molar ratio of boron oxide to carbon is from 1:2.9 to 1:3.5 or from 1:3.0 to 1:3.2. In further embodiments, the ratio of boron oxide to carbon is from 1:2.92 to 1:2.99. In a series of experiments, the inventors found that a ratio of 1:2.99 gave the minimum level of residual carbon.

To retain the carbon source (and boron source, where present) in solution prior to formation of the solid precursor particles, it may be necessary to heat the liquid precursor. For example, the liquid precursor may be maintained at a temperature of at least 50° C., at least 70° C. or at least 90° C.

The step of forming the solid precursor particles from the liquid precursor may comprise forming droplets of the liquid precursor and then evaporating the solvent (e.g. water) from the droplets (i.e. drying the droplets) to form solid precursor particles. This may be achieved by forming the droplets in a hot chamber or in the presence of hot gas so that the liquid in the droplets is evaporated almost as soon as the droplets are formed. The droplets may be formed by spraying or electro-spraying the liquid precursor.

Thus, in some embodiments, forming the solid precursor particles comprises spray drying the liquid precursor. Spray drying is a well-known method of producing a dry powder from a liquid or slurry. The liquid or slurry is introduced into a spray dryer instrument, where it is dispersed by a spray nozzle into fine droplets inside a chamber. At the same time, a large volume of hot gas is introduced into the chamber which evaporates the liquid from the droplets, thereby forming dry solid precursor particles.

Spray drying may be carried out using any conventional spray dryer known to those skilled in the art. In some embodiments, spray drying comprises forming droplets of the liquid precursor having an average diameter of less than 20 μm, less than 15 μm or less than 10 μm. In some embodiments, the pressure of the gas which enters the spray nozzle to break up the liquid is from 1 to 2 atmospheres, for example 1.25 atmospheres. The gas may be air or it may be an inert gas if the solution is air-sensitive. In some embodiments, the rate of gas flow is from 20 to 80 m³/hour, from 30 to 70 m³/hour or from 40 to 60 m³/hour, for example 45 m³/hour. The rate of gas flow will be dependent on the properties of the liquid precursor. In general, a higher flow rate results in smaller droplets which are quicker to dry to form solid particles.

The pump speed (i.e. the rate at which the liquid precursor is fed through the spray nozzle) will depend on the fluidity of the liquid and the type of liquid pump. A lower speed results in a lower concentration of liquid droplets, generally meaning that all of the liquid droplets produced by the nozzle can be dried quickly. If the pump speed is too high, a high concentration of liquid droplets is formed. This means that the time taken to dry the droplets may be increased, which can result in the particles having reduced spherical morphology. Partially dried precursor particles may stick to the walls of the chamber and reduce the collection yield of the solid precursor particles. In some embodiments, the pump speed is from 20 to 30 g/min or from 25 to 28 g/min.

The temperature of the inlet gas (i.e. the gas released into the chamber to dry the droplets) may be from 100 to 250° C., from 150 to 220° C., or from 170 to 200° C. In some embodiments, the temperature of the inlet gas is 190° C. If the inlet gas temperature is too low, it will take longer to dry the droplets. If the gas is too hot this can lead to aggregation of the solid precursor particles. Such aggregates may hinder the pyrolysis process or even the subsequent carbothermal reduction.

Typically, the pressure in the drying chamber is atmospheric pressure or slightly higher than atmospheric pressure.

In some embodiments, the outlet temperature of the gas from the drying chamber is from 70 to 100° C., for example approximately 90° C. This temperature will depend on the concentration of liquid droplets which are produced by the spray nozzle. A low concentration of droplets results in a higher outlet temperature, while a high concentration of droplets results in a lower outlet temperature.

It will be appreciated that the conditions provided above may need to be varied depending on the nature of the liquid precursor and its constituents.

Solid precursor particles formed by spray-drying may be collected by any suitable means, typically in a cyclone separator which forms part of the spray dryer device.

In some embodiments, forming the solid precursor particles comprises electro-spraying the liquid precursor to form droplets, followed by evaporating the liquid from the droplets to form solid precursor particles. Electrospraying (electrohydrodynamic spraying) is a process of simultaneous droplet generation and charging by means of electric field. In this process, liquid flowing out from a capillary nozzle maintained at high potential is subjected to an electric field, which causes elongation of the meniscus to a form of jet or spindle. The jet deforms and disrupts into droplets due mainly to electrical force. The diameter of the droplets formed is influenced by factors including the applied potential to the tip of electrospray and the liquid flow rate. The average diameter of the droplet may be from 20 to 50 μm.

As with the spray drying process, the liquid droplets formed by electrospraying may be formed in a heated chamber and/or in the presence of hot gas to evaporate the liquid from the droplets, thereby forming solid precursor particles.

In some alternative embodiments, forming the solid precursor particles comprises freeze-drying (lyophilising) the liquid precursor. During freeze-drying, the precursor liquid is sprayed into fine liquid droplets which are frozen rapidly and dried under a vacuum by sublimation of the solvent (e.g. water or volatile organic liquid) to form the solid precursor particles. The average diameter of the liquid droplets may be from 40 to 90 μm. The droplets may be dried at a temperature of from about −50° C. to about 20° C., and under a pressure of from about 3.5 Pa to about 20 Pa. The time required for freezing and drying the droplets may be from about 30 minutes up to about 20 hours, depending on the temperature and the pressure used.

The formation of solid precursor particles directly from a liquid precursor eliminates the need for an extensive grinding process to form particles from a solid precursor mass, as in conventional methods. The use of spray drying or electro-spraying is particularly advantageous because it allows the size distribution of the particles to be closely controlled.

The temperature of pyrolysis is dependent on the composition of the liquid precursor, in particular on the carbon source used. In some embodiments, thermogravimetric analysis (TGA) of the solid precursor particles is carried out prior to pyrolysis. Thermogravimetric analysis is a technique in which the mass of a substance is monitored as a function of temperature or time as a sample of the substance is subjected to a controlled temperature program in a controlled atmosphere. It can be used to characterise the chemical composition of the precursor particles so that the most suitable conditions for pyrolysis are selected. TGA may carried out using a conventional thermogravimetric analyzer, such as those supplied by PERKINELMER.

In some embodiments, pyrolysis of the solid precursor particles is carried out at a temperature of at least 300° C., at least 350° C., at least 400° C., at least 450° C., at least 500° C. or at least 600° C., for example 650° C. Where the carbon source is modified starch, thermal decomposition occurs at a temperature of between 350° C. and 450° C., although a temperature as high as 650° C. may be used to ensure that decomposition is complete. Pyrolysis may be carried out under an atmosphere of any suitable inert gas (i.e. a gas that is non-reactive under the conditions employed), such as argon, helium or nitrogen.

In embodiments wherein the liquid precursor comprises both a boron source and a carbon source, the resultant solid precursor particles consist of a mixture of the carbon source material and the boron source material. During the pyrolysis process, these particles are transformed into a mixture of finely dispersed phases of the boron source (e.g. B₂O₃) and carbon. In embodiments wherein only the carbon source is present in the liquid precursor (and the boron source is introduced later as a gas), the pyrolysis process converts the carbon source into carbon.

Pyrolysis is carried out for a time sufficient for this transformation to occur. The amount of time required for pyrolysis to be complete is dependent on the temperature of pyrolysis and, in some cases, on the quantity of precursor particles. In some embodiments, pyrolysis is carried out for a period of time of at least 1 hour, at least 2 hours, at least 4 hours or at least 6 hours. Pyrolysis may be carried out in any suitable furnace.

Carbothermal reduction of the pyrolysed solid precursor particles is the final step in the process. This step constitutes heating the particles at very high temperatures.

In embodiments wherein the boron source is introduced into the liquid precursor, B₂O₃ is present in the solid pyrolysed precursor particles. During the carbothermal reduction step, the B₂O₃ in the particles reacts with the carbon to form boron carbide (B₄C). In embodiments wherein a gaseous boron source is introduced during the carbothermal reduction process, the boron-containing gas reacts with the carbon present in the pyrolysed precursor particles to form boron carbide.

In some embodiments, carbothermal reduction is carried out at a temperature of at least 1000° C., at least 1200° C. or at least 1400° C., for example 1450° C. The reduction process may be carried out under an atmosphere of any suitable inert gas, such as argon, helium or nitrogen. Heating is carried out for a time sufficient for the reaction to form boron carbide to be completed. In some embodiments, carbothermal reduction of the pyrolysed solid precursor particles is carried out for at least 1 hour, at least 2 hours or at least 4 hours. For example, the particles may be heated (i.e. subjected to carbothermal reduction) for approximately 5 hours.

Carbothermal reduction may be carried out in any suitable furnace. This final heat treatment step may be carried out in the same furnace as the pyrolysis process. The pyrolysed solid precursor particles may be removed from the furnace and allowed to cool prior to carbothermal reduction. Alternatively, the carbothermal reduction step may be continuous with the pyrolysis step. For example, a heating cycle may be used which holds the solid precursor particles at a first temperature for a first period of time during which pyrolysis occurs, followed by heating the solid precursor particles to a second temperature for a second period of time for the carbothermal reduction to take place.

The method of the invention also allows the production of boron carbide powder which is doped with another element or elements of interest (referred to as a ‘dopant’). Such elements may be metals (e.g. tungsten, titanium) or non-metals (e.g. silicon). Either a single element or multiple elements can be introduced into the boron carbide. Thus, in some embodiments the method comprises introducing at least one additional element (a dopant) during at least one of steps (i) to (iv), thereby producing a doped boron carbide powder.

The dopant(s) may be introduced at the liquid precursor stage of the process. A source of the additional element (dopant) may be in the form of a liquid or a solid. Thus, in some embodiments, the method comprises forming a liquid precursor from a carbon source, a source of at least one additional element (a dopant) and, optionally, a boron source.

Alternatively, the dopant may introduced during the carbothermal reduction (heat treatment) stage of the method in the form of a gas. Thus, in some embodiments, the method comprises subjecting pyrolysed solid precursor particles to carbothermal reduction in the presence of a gaseous source of a dopant. For example, if the dopant is silicon, carbothermal reduction may be carried out in the presence of silane gas. In some embodiments, both the boron source and the dopant are introduced in the form of a gas during carbothermal reduction.

The at least one additional element (dopant) may be silicon. A suitable source of silicon may be silicone oil (polydimethylsiloxane (PDMS)), for example, in the form of a modified silicone fluid such as polyethylene glycol-modified silicone fluid (commercially available e.g. from Basildon Chemicals). The silicon source may be soluble in the liquid precursor, or it may form an emulsion of fine droplets suspended in the liquid precursor. Modified silicone, such as PEG-modified PDMS, may be preferred in some instances because it is soluble in water and therefore can form a molecular mixture with the carbon and boron (when present) sources in a liquid precursor solution. However, it will be appreciated that any suitable source of silicon may be used.

The amount of the dopant source added may be sufficient to achieve an amount of the dopant in the boron carbide of up to 1 wt %, up to 2 wt %, up to 3 wt % or up to 5 wt %, based on the total mass of the doped boron carbide product. For example, the final powder may comprise 98 wt % B₄C and 2 wt % dopant.

According to a second aspect of the present invention there is provided boron carbide powder having a residual carbon content of no greater than 1.5 at %.

In some embodiments the residual carbon content of the boron carbide powder is no greater than 1 at %, no greater than 0.8 at % or no greater than 0.5 at %, e.g. 0.2-0.8 at %.

In some embodiments, the particles of boron carbide powder have equiaxed morphology.

In some embodiments, the boron carbide powder is doped with at least one additional element. The element may be a metal (e.g titanium, tungsten) or a non-metal (e.g. silicon).

In some embodiments, the boron carbide powder has an average particle size (D50) of less than 10 μm, less than 8 μm, less than 7 μm, less than 6 μm, less than 5 μm or less than 3 μm. In some embodiments, the boron carbide has an average particle size (D50) of no greater than 9 μm, no greater than 7 μm or no greater than 5 μm.

According to a third aspect of the invention, there is provided boron carbide powder obtainable by a process in accordance with the first aspect of the invention.

It will be appreciated that the embodiments described above in relation to the first or second aspects of the invention may apply equally to the first, second or third aspects of the invention.

Embodiments of the present invention will now be described by way of example with reference to the accompanying Figures, in which:

FIG. 1 is a SEM image of spray-dried solid precursor particles, showing a bimodal size distribution with spherical morphology;

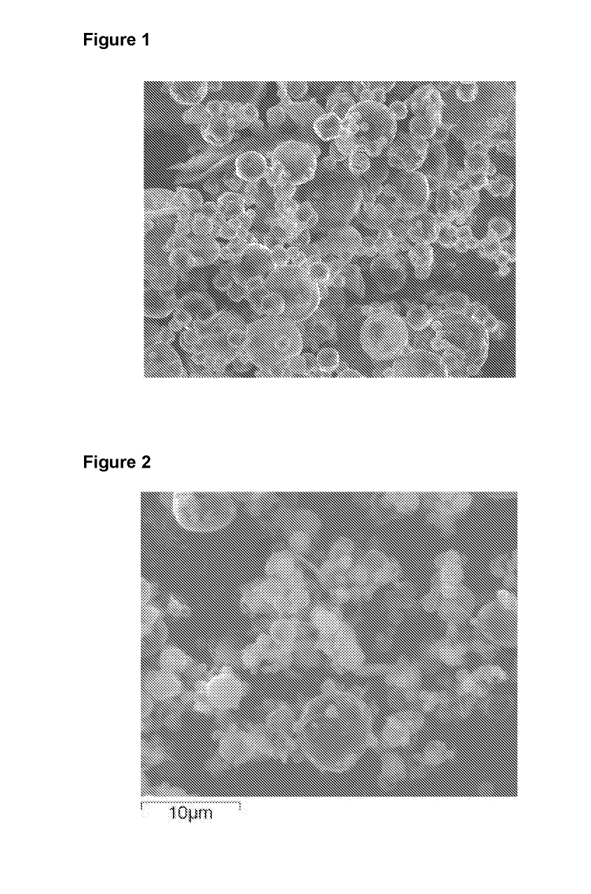

FIG. 2 is a SEM image of pyrolysed solid precursor particles, showing a biomodal size distribution and spherical morphology similar to the spray dried precursor particles of FIG. 1;

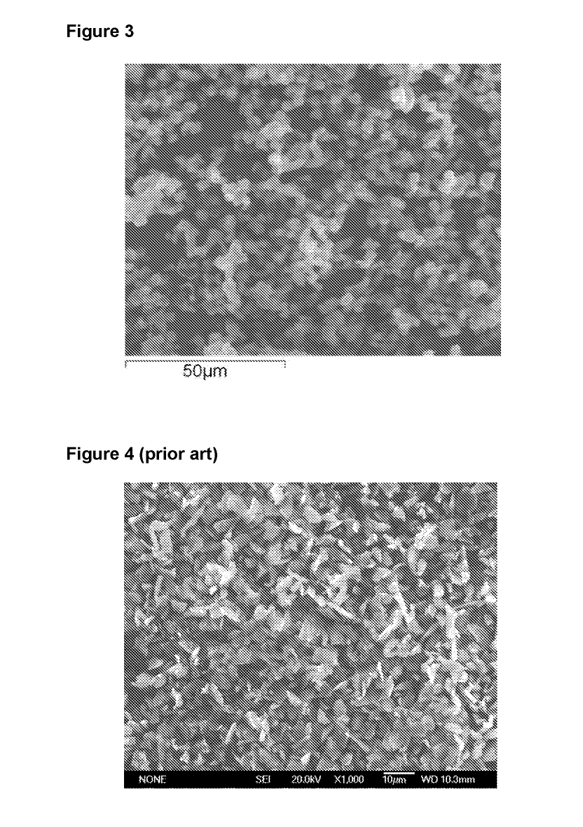

FIG. 3 is a SEM image of boron carbide powder formed by the carbothermal reduction of pyrolysed solid precursor particles;

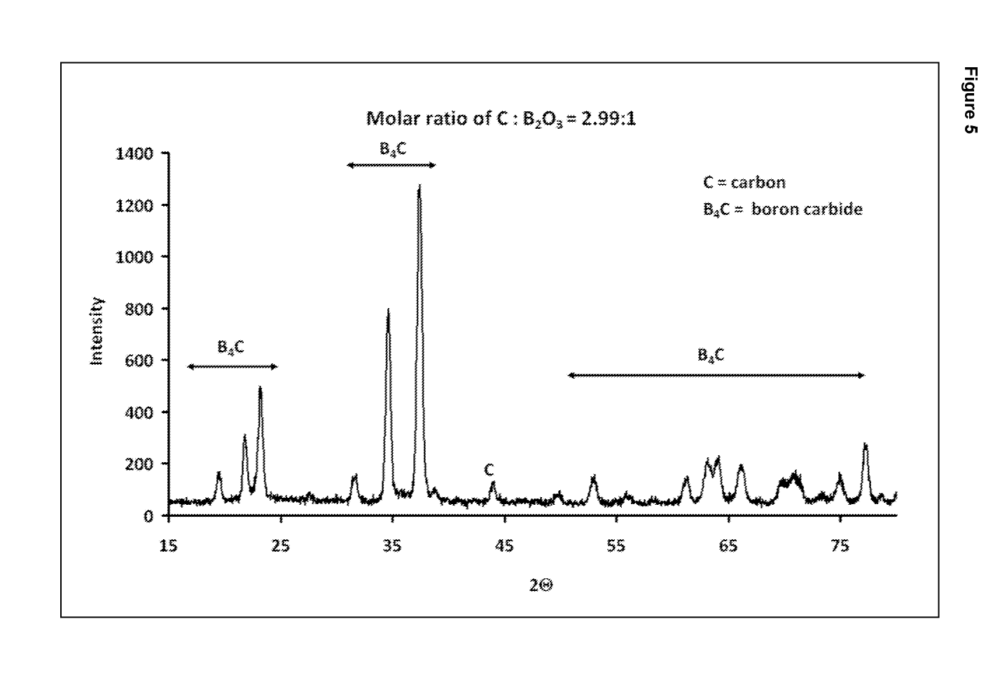

FIG. 4 is a scanning electron microscope (SEM) image of commercial grade boron carbide (prior art);

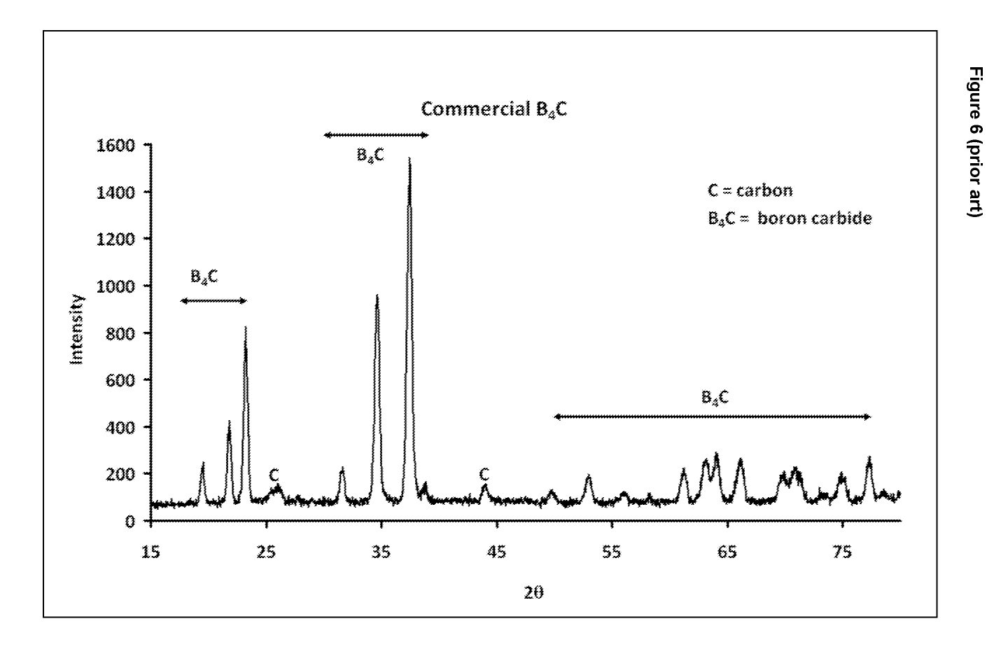

FIG. 5 is an XRD spectrum of boron carbide powder produced in accordance with an embodiment of the present invention;

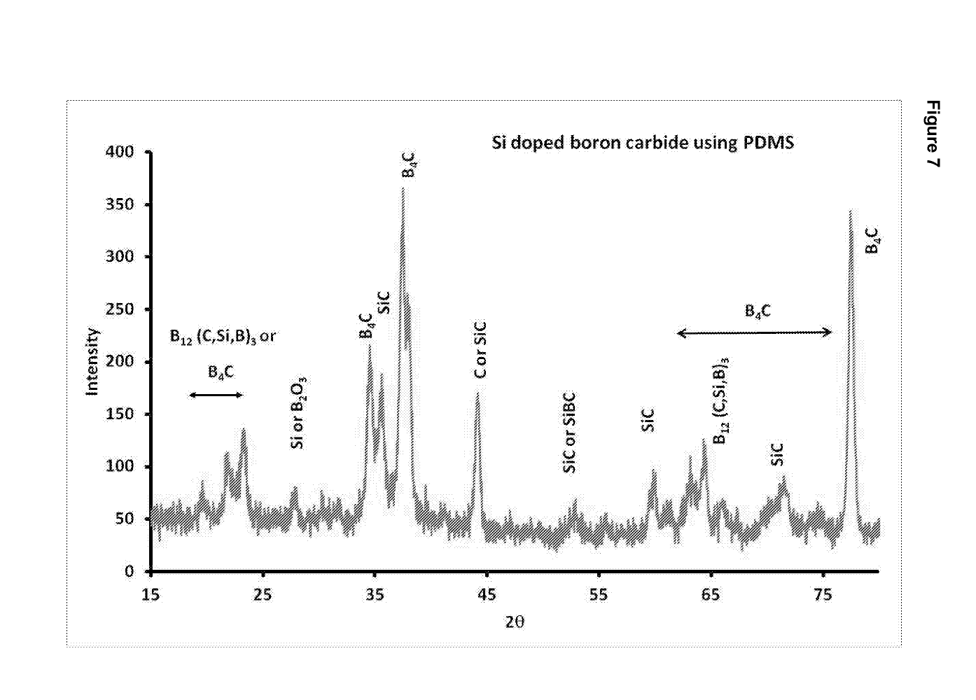

FIG. 6 is an XRD spectrum of commercial grade boron carbide powder showing residual carbon (prior art); and

FIG. 7 is an XRD spectrum of silicon-doped boron carbide powder produced in accordance with an embodiment of the present invention.

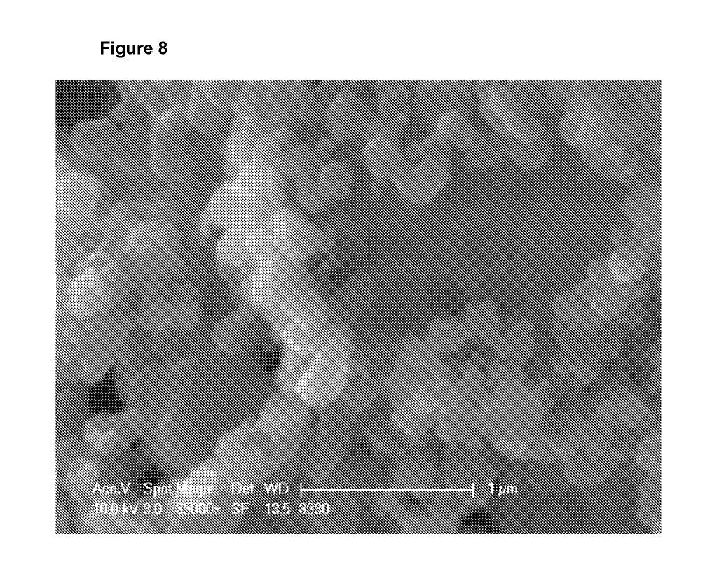

FIG. 8 is a scanning electron micrograph (SEM) of silicon-doped boron carbide powder produced in accordance with an embodiment of the present invention.

### EXAMPLE 1

### Spray Drying

An aqueous solution was prepared by adding 16.5 g B₂O₃ to 900 ml distilled water. The solution was heated to a temperature of 100° C. to form boric acid, to which was added 28.34 g of modified starch to form an aqueous liquid precursor containing boron and carbon.

The aqueous liquid precursor was maintained at a temperature of at least 90° C. and pumped through a spray dryer under the following conditions to give dry solid precursor particles:
Air pressure: 1.25 atmospheres
Air flow rate: 45 m³/hour
Pump speed: approximately 26 g/min
Inlet gas temp: 190° C.
Outlet gas temp: ˜90° C.

The solid precursor particles were collected from the spray dryer through a cyclone separator. The particles were examined by SEM and the resulting image is shown in FIG. 1. The solid precursor particles show a biomodal size distribution with spherical morphology.

The solid precursor particles were then loaded into alumina crucibles and subjected to pyrolysis in a tube furnace. Pyrolysis was carried out under an argon atmosphere at 650° C. with a holding time of 2 hours, before being cooled to room temperature for removal from the furnace.

The pyrolysed solid precursor particles were examined by SEM and the resulting image is shown in FIG. 2. The pyrolysed particles show a biomodal size distribution and spherical morphology similar to the spray dried solid precursor particles shown in FIG. 1.

The pyrolysed particles were then loaded into alumina crucibles and heated in the tube furnace to 1450° C. under argon for 5 hours. The particles were allowed to cool to room temperature before removal from the furnace.

The resulting heat treated boron carbide powder was then examined using SEM. The boron carbide powder was found to have an average particle size of about 5 μm and equiaxed morphology, as shown in FIG. 3. In contrast, commercial grade boron carbide was shown to have an average particle size of 10 μm with faceted morphology, as can be seen from FIG. 4. Faceted morphology is less desirable than equiaxed morphology for use in pressureless sintering to achieve dense components. It is believed that equiaxed particles tend to form slightly denser green bodies due to better packing.

XRD spectrum analysis of the boron carbide powder was carried out, the results of which are which are shown in FIG. 5. XRD analysis shows the powder produced by the method of the invention to contain very little residual carbon, and less residual carbon than the commercial grade boron carbide powder shown in FIG. 6.

The process of the invention thus yields boron carbide powder having an average particle size of 5 μm without the need for additional milling or grinding, thereby significantly reducing the cost of production. Due to the small particle size and the even size distribution, the powders produced by the process are suitable for consolidation using pressure-less sintering, wherein the green body is subjected to high temperature but not high pressure. This will also significantly reduce the cost of producing high-density components from boron carbide powder.

### EXAMPLE 2

### Production of Doped Boron Carbide Powder

An aqueous solution was prepared by adding 16.56 g B₂O₃ to 800 ml deionised water. The solution was heated to a temperature of 100° C. to form boric acid, to which was added 28.37 g of modified starch and 26.20 g of BC 2153 EO modified silicone (purchased from Basildon Chemicals) to form an aqueous liquid precursor solution containing boron, carbon and silicon.

Solid precursor particles were prepared from the aqueous liquid precursor by spray drying in accordance with the method of Example 1. The solid precursor particles were pyrolysed and heat treated (i.e. subjected to carbothermic reduction) as in Example 1 to produce Si-doped boron carbide powder.

XRD spectrum analysis of the Si-doped boron carbide powder was carried out, the results of which are which are shown in FIG. 7. The spectrum shows the presence of boron carbide and silicon carbide (SiC). The silicon doped boron carbide powder was then examined using SEM. The Si-doped boron carbide powder was found to have an average particle size of about 0.25 μm and equiaxed morphology, as shown in FIG. 8.

1. A method of producing boron carbide powder, the method comprising:
(i) forming a liquid precursor from a carbon source;
(ii) forming solid precursor particles from the liquid precursor;
(iii) subjecting the solid precursor particles to pyrolysis; and
(iv) subjecting the pyrolysed solid precursor particles to a carbothermal reduction process,
wherein a boron source is introduced during one of steps (i) to (iv) such that the carbothermal reduction process results in the production of boron carbide powder.

2. The method according to claim 1, wherein the liquid precursor is a solution and preferably an aqueous solution.

3. The method according to claim 1, wherein the carbon source is selected from the group consisting of sugars, polysaccharides, hydrocarbons, acids, esters and alcohols and is preferably starch or modified starch.

4. The method according to claim 1, wherein the step of forming solid precursor particles from the liquid precursor comprises forming droplets of the liquid precursor and drying the droplets to form solid precursor particles.

5. The method according to claim 4, wherein the droplets are formed by electro-spraying the liquid precursor.

6. The method according to claim 5, wherein the step of forming the solid precursor particles from the liquid precursor comprises spray drying the liquid precursor.

7. The method according to claim 1, wherein the step of forming solid precursor particles from the liquid precursor comprises freeze-drying the liquid precursor.

8. The method according to claim 1, further comprising thermogravimetric analysis of the solid precursor particles prior to pyrolysis.

9. The method according to claim 1, wherein pyrolysis of the solid precursor particles is carried out at a temperature of at least 300° C.

10. The method according to claim 1, wherein carbothermal reduction of the pyrolysed solid precursor particles is carried out at a temperature of at least 1000° C.

11. The method according to claim 1, wherein the liquid precursor is formed from a carbon source and a boron source, preferably boron oxide.

12. The method according to claim 11, wherein the molar ratio of boron oxide to carbon in the liquid precursor is from 1:2.9 to 1:3.5.

13. The method according to claim 1, wherein at least one of steps (ii), (iii) and (iv) is carried out in the presence of a gaseous boron source.

14. The method according to claim 13, wherein the pyrolysed solid precursor particles are subjected to carbothermal reduction in the presence of a gaseous boron source.

15. The method according to claim 1, further comprising introducing at least one additional element during at least one of steps (i) to (iv) so as to produce a doped boron carbide powder.

16. The method according to claim 15, wherein the method comprises forming a liquid precursor from a carbon source, a source of the least one additional element and, optionally, a boron source.

17. The method according to claim 15, wherein the method comprises subjecting pyrolysed solid precursor particles to carbothermal reduction in the presence of a gaseous source of the at least one additional element, wherein the at least one additional element is silicon, tungsten and/or titanium.

18. (canceled)

19. A boron carbide powder having a residual carbon content of no greater than 1.5 at %.

20. The boron carbide powder according to claim 19, wherein the particles of boron carbide powder have equiaxed morphology.

21. The boron carbide powder according to claim 19, wherein the powder is doped with at least one additional element.

22. (canceled)
